(19) United States
(12) Patent Application Publication
(10) Pub. No.: US 2006/0240313 A1
(43) Pub. Date: Oct. 26, 2006

(54) Gas diffusion layer paste, gas diffusion layer, polymer electrolyte fuel cell and method of preparing gas diffusion layer paste

(76) Inventors: Hirofumi Takami, Ora-gun (JP); Masataka Kadowaki, Ota-city (JP); Keigo Miyai, Ora-gun (JP); Shigeru Sakamoto, Ota-city (JP)

Correspondence Address: MCDERMOTT WILL & EMERY LLP, 600 13TH STREET, N.W., WASHINGTON, DC, 20005-3096, US

(21) Appl. No.: 11/390,420

(22) Filed: Mar. 28, 2006

(30) Foreign Application Priority Data
Mar. 28, 2005 (JP) 2005-092502
Mar. 28, 2005 (JP) 2005-092503

(51) Int. Cl. H01M 4/94; H01B 1/00; H01B 1/20; H01M 4/88

(52) U.S. Cl. 429/42; 429/44; 252/500; 502/101

(57) ABSTRACT

A polymer electrolyte fuel cell includes an electrolyte, a first electrode and a second electrode. The first electrode is provided with a catalyst layer which has a catalytic function, a conductive material and a water management layer which is conductive and which manages water moving between the catalyst layer and the base material.

### BACKGROUND OF THE INVENTION

1. Field of the Invention

The present invention generally relates to a fuel cell and, more particularly, to a fuel cell in which the productivity of a gas diffusion layer in a polymer electrolyte fuel cell is improved.

2. Description of the Related Art

Energy industries remain one of the key industries even in an age when information technology and biotechnology are pursued worldwide. Expectations for new types of energy are mounting as people have growing awareness of environmental issues such as prevention of global warming. In addition to providing environmental benefits, most new types of energy allow distributed energy production at a location relatively close to utility customers, thus providing advantages of reduced transmission loss and improved security in supplying electric power. Spillover effects of creating new peripheral industries are expected from developing new energy sources. Efforts to develop new energy sources began about 30 years ago when there was an oil crisis. Currently, reusable energy such as solar power, recycled energy such as waste power generation, high-efficiency energy sources such as fuel cells and alternative energy represented by clean-energy cars are being developed for practical applications.

A fuel cell is one of the energy sources that are focuses of attention in the industry. A fuel cell generates electricity and heat at the same time by inducing chemical reaction between hydrogen and oxygen, hydrogen being generated by reaction between water vapor and natural gas, methanol or the like, and oxygen being derived from atmosphere. The only byproduct from power generation using a fuel cell is water, and high efficiency is ensured even in a low-output range. An added advantage is that power generation is stable irrespective of weather conditions. Particularly, a polymer electrolyte fuel cell is viewed as one of next-generation standards in vehicle, mobile and other applications as well as in stationary applications such as home use.
[patent document No. 1]
JP 2004-185905 A

In anticipation that polymer electrolyte fuel cells will enjoy widespread use, efforts are being made to improve cell performance, extend fuel cell life and lower the cost of fuel cells. Reduction of financial burden upon the user is essential to promote use and therefore lower-cost manufacturing of fuel cells is an important goal to be achieved. Meanwhile, the gas diffusion layer of patent document No. 1 listed as describing a background art provides satisfactory cell performance but requires prolonged time for preparation. As such, it presents a problem in productivity.

### SUMMARY OF THE INVENTION

A general purpose of the present invention is to provide a fuel cell in which the productivity in preparing a gas diffusion layer is improved, i.e., time required to prepare a gas diffusion layer is reduced. An additional purpose of the present invention is to provide a fuel cell in which the productivity in preparing a gas diffusion layer is improved, i.e., time required to prepare a gas diffusion layer is reduced, while maintaining or improving cell performance.

In at least one embodiment of the present invention, a gas diffusion layer paste according to comprises: a conductive material; a water repellent material; and a material with binding capacity. Binding capacity in this case is defined as a property that binds non-viscous or loosely adhering materials so as to produce a viscous state. According to this embodiment, a gas diffusion layer paste with desired water repellency and viscosity suitable for preparation work is achieved.

The water repellent material may be a first fluororesin, and the material with binding capacity may be a second fluororesin having a larger average molecular weight than the first fluororesin. The first fluororesin may be polytetrafluoroethylene. By mixing the first fluororesin and the second fluororesin with larger average molecular weight than the first fluororesin, it is easy to achieve desired water repellency and viscosity by configuring the mixing ratio. Another advantage is that materials are easily available.

In at least one another embodiment, a gas diffusion layer paste comprises: a conductive base material; and a water management layer which is conductive and which manages moving water. The water management layer may include a conductive material and a water repellent material. According to this embodiment, flooding of the gas diffusion layer is prevented and the flow of gas (reacting fluid) and liquid such as generated water is allowed without causing accumulation thereof in the water management layer.

The base material may include a third fluororesin having water repellency and sticking tendency. The term “sticking tendency” refers to the property of materials to adhere to each other firmly. According to this embodiment, flooding in the base material is also prevented and the water management layer is firmly secured in the base material.

In at least one other embodiment, a gas diffusion layer comprise; a first fluororesin having water repellency; and a second fluororesin having binding capacity. The gas diffusion layer may further comprise a third fluororesin having water repellency and sticking tendency. According to this embodiment, not only flooding of the gas diffusion layer is prevented but also workability, and the initial performance and durability of fuel cell using the inventive gas diffusion layer is improved, by using fluororesins of different properties.

In at least one other embodiment, a polymer electrolyte fuel cell comprises: an electrolyte; a first electrode provided on one side of the electrolyte; and a second electrode provided on the other side of the electrolyte, wherein the first electrode is provided with a catalyst layer having a catalytic function, a conductive base material and a water management layer which is conductive and which manages water moving between the catalyst layer and the base material. According to this embodiment, the flow of reacting fluid supplied to the catalyst layer and generated water discharged from the catalyst layer is allowed, without causing accumulation thereof.

In at least one other embodiment, a polymer electrolyte fuel cell comprises: an electrolyte; a first electrode provided on one side of the electrolyte; and a second electrode provided on the other side of the electrolyte, wherein the first electrolyte is provided with a catalyst layer which has a catalytic function and a gas diffusion layer according to one of aforementioned embodiments. According to this embodiment, the flow of reacting fluid supplied to the catalyst layer and generated water discharged from the catalyst layer is allowed, without causing accumulation thereof. In addition, productivity of a polymer electrolyte fuel cell is improved by using a gas diffusion layer that offers excellent workability.

In at least one other embodiment, a method of preparing gas diffusion layer paste comprises: preparing conductive paste by mixing a conductive material, a detergent and a solvent; and mixing the conductive paste, a first fluororesin and a second fluororesin. The method of preparing gas diffusion layer paste may further comprise cooling the conductive paste before mixing the conductive paste, the first fluororesin and the second fluororesin. According to this embodiment, a gas diffusion layer paste in which multiple types of fluororesins are mixed can be prepared easily.

In at least one other embodiment, a gas diffusion layer comprises: a conductive base material; and a water management layer which is provided on one side of the base material and which includes a conductive material and a water repellent material, wherein the water management layer is provided on the base material in the volume range of 1.92 mg/cm²−2.24 mg/cm². According to this embodiment, flooding in the water management layer is prevented and the initial performance and durability of fuel cell using the inventive gas diffusion layer is improved.

The water management layer may include a first fluororesin as the water repellent material, and a second fluororesin which has binding capacity and which has a larger average molecular weight than the first fluororesin. Binding capacity in this case is defined as a property that binds non-viscous or loosely adhering materials so as to produce a viscous state. According to the embodiment, not only flooding is prevented in the water management layer but also viscosity of the water management layer suitable for preparation work is obtained by adjustment, ensuring that the water management layer is provided with required water repellency and sticking tendency (property whereby the water management layer is firmly secured in the base material).

The base material may include a third fluororesin which has water repellency and sticking tendency. The term “sticking tendency” refers to the property of materials to adhere to each other firmly. According to this embodiment, flooding in the base material is also prevented and the water management layer is firmly secured in the base material.

In at least one other embodiment, a fuel cell comprises: an electrolyte; a first electrode provided on one side of the electrolyte; and a second electrode provided on the other side of the electrolyte, wherein the first electrode is provided with a first catalyst layer which has a catalytic function and a first gas diffusion layer using the gas diffusion layer according to claim 14. According to this embodiment, battery performance is maintained or improved, and productivity in preparing a gas diffusion layer is improved.

The second electrode may be provided with a second catalyst layer which has a catalytic function, and a second gas diffusion layer including a base material and a water management layer, and the weight of the water management layer formed in the first gas diffusion layer per unit area may be larger than that of the water management layer formed in the second gas diffusion layer. According to this embodiment, it is ensured that reacting fluid is supplied from the first gas diffusion layer to the catalyst layer and generated water from the first catalyst is discharged through the first gas diffusion layer in a balanced manner. The supply of reacting fluid and humidifier water from the second gas diffusion layer to the second catalyst layer is also performed in a balanced manner.

It is to be noted that any arbitrary combination or rearrangement of the above-described structural components and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a schematic diagram showing the structure of a single cell according to an embodiment of the present invention;

FIG. 2 is a flowchart showing steps of preparing a gas diffusion layer according to a first example of practicing the embodiment;

FIG. 3 is a flowchart showing steps of preparing a gas diffusion layer according to a second example of practicing the embodiment; and

FIG. 4 is a graph showing a cell voltage of a single cell using a gas diffusion layer according to the embodiment.

### DETAILED DESCRIPTION OF THE INVENTION

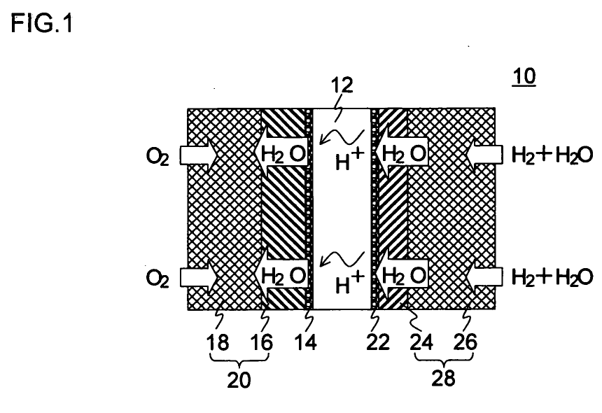

In a fuel cell according to an embodiment of the present invention, a gas diffusion layer is formed by coating a base material (carbon paper, carbon woven or nonwoven fabric) with a viscous carbon paste primarily composed of carbon black. As shown in FIG. 1, the same type of carbon paper is used to form gas diffusion layers 20 and 28 from productivity considerations. Generated water is discharged from a catalyst layer 14. Humidifier water is supplied via an anode to a polymer electrolyte membrane 12. Alternatively, different types of pastes (water management layers) 16 and 24 may be used to coat base materials 18 and 26 facing the anode and cathode, respectively, in order to retain moisture in the polymer electrolyte membrane 12. That is, the cathode-side water management layer 16, prepared by coating the base material 18 with paste for forming a gas diffusion layer (hereinafter, referred to as gas diffusion layer paste) and then drying and heat-treating the material, is less water repellent (i.e., with relatively small amount of fluororesin) than the anode-side layer. This is to remove generated water from the catalyst layer 14 by capillary action, so as to prevent the supply of reacting fluid to the catalyst layer 14 from being blocked as a result of a gas supply passage being blocked by generated water. Meanwhile, the anode-side water management layer 24, prepared by coating the base material 26 with gas diffusion layer paste and then drying and heat treating the material, is more water repellent (i.e., with relatively large amount of fluororesin). This is to retain moisture of the polymer electrolyte membrane 12 by blocking moving water arriving from the cathode by back diffusion.

Fluorocarbon resin which is generally available (hereinafter, referred to as polymer fluororesin) exhibits binding capacity. Thus, introduction of a large quantity of polymer fluororesin in the gas diffusion layer paste results in increased viscosity through mixing and coating operations, turning the paste into an aggregate. This makes the coating process difficult to perform. A description will now be given of a method to ensure that each gas diffusion layer paste is provided with desired balance of water repellency and binding capacity by introducing low molecular fluororesin with a small average molecular weight and with considerably low binding capacity. Low molecular fluororesin assumes the function provides the paste with water repellency and polymer fluororesin provides binding capacity.

### EXAMPLE 1

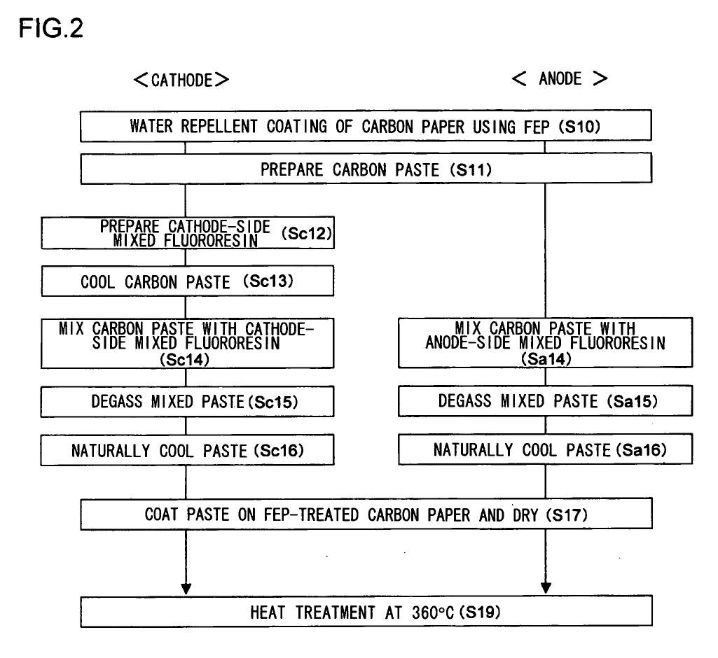

As shown in FIG. 2, carbon paper (TGPH060H from Toray Industries Inc.) that serves as a gas diffusion layer base material is immersed in an FEP dispersed solution such that the weight ratio is carbon paper FEP (tetra-fluoroethylene hexa-fluoro-propylene copolymer)=95:5 (at the cathode) and 60:40 (at the anode). The carbon paper is then dried at 60° C. for an hour and heat-treated at 380° C. for 15 minutes (water repellant coating using FEP) (S10). In this way, the carbon paper is substantially evenly coated with a water repellent agent.

Carbon paste is prepared by evenly mixing carbon black (VulcanXC72R from Cabot Corporation) by a universal mixer (from Dalton Co., Ltd.) with Terpineol (from Kishida Chemical Co., Ltd.) and Triton (non-ionic detergent also from Kishida) as solvents at room temperature for 60 minutes such that the weight ratio is carbon black:Terpineol:Triton=20:150:3 (S11).

The cathode-side mixed fluororesin is prepared by mixing low-molecular fluororesin (Lubron LDW40E from Daikin Industries, Ltd.) and polymer fluororesin (PTFE30J from E.I. du Pont de Nemours and Company) such that the weight ratio of fluororesin included in a dispersed solution is low molecular fluororesin:polymer fluororesin=20:3 (Sc12). The carbon paste is introduced into a hybrid mixer container and allowed to cool to 10-12° C. (Sc13). The cathode-side mixed fluororesin is introduced into the cooled carbon paste such that the weight ratio is carbon paste:cathode-side mixed fluororesin (fluororesin content included in a dispersed solution)=31:1 and mixed by a hybrid mixer (EC500 from Keyence Corporation) in a mixing mode for 12-18 minutes (Sc14) The mixing operation is halted when the temperature of the paste is 50-55° C. When the temperature of the paste reaches 50-55° C., the hybrid mixer is switched from a mixing mode to a degassing mode to allow degassing for 1-3 minutes (Sc15) The paste thus degassed is allowed to be naturally cooled (Sc16) so as to complete the paste for the cathode-side gas diffusion layer.

The carbon paste and the low molecular fluororesin are introduced into a hybrid mixer container such that the weight ration is carbon paste:low molecular fluororesin (hereinafter, referred to as anode-side fluororesin) (fluororesin content included in a dispersed solution)=26:3 and mixed in a mixing mode of the hybrid mixer for 15 minutes (Sa14). After mixing, the hybrid mixer is switched from the mixing mode to the degassing mode to allow degassing for 4 minutes (Sa15). If supernatant is collected in the upper portion of the degassed paste, the anode-side gas diffusion layer paste is completed by discarding the supernatant and allowing the paste to be naturally cooled (Sa16).

The surface of the carbon paper water repellent coated using FEP is evenly coated with the gas diffusion layer paste cooled to room temperature and then dried by a hot air dryer (from Thermal Co., Ltd.) at 60° C. for 60 minutes (S17). Finally, the gas diffusion layer is completed when heat treated at 360° C. for 2 hours (S19).

### EXAMPLE 2

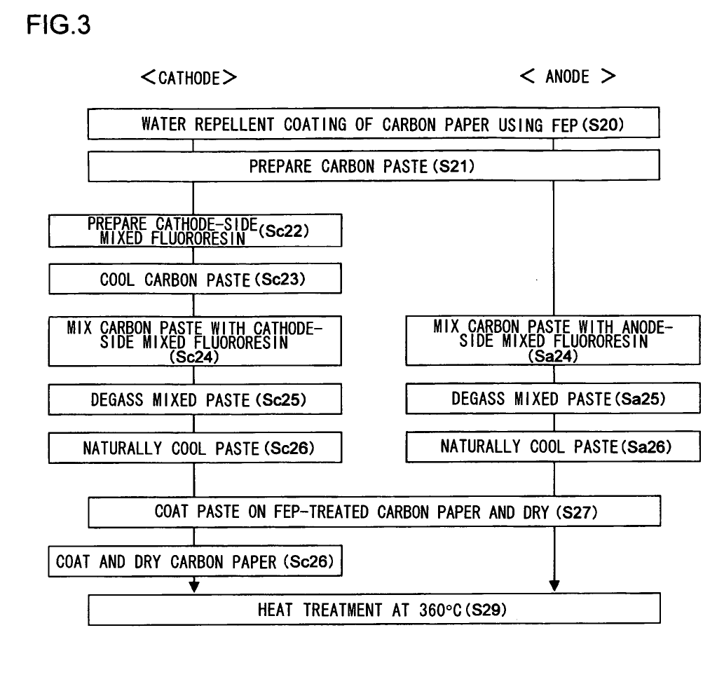

As shown in FIG. 3, the carbon paper (TGPH060H from Toray Industries Inc.) that serves as a gas diffusion layer base material is water repellent coated using FEP as in Example 1 (S20).

As in Example, 1, carbon paste is prepared by evenly mixing carbon black by a universal mixer with Terpineol and Triton at room temperature for 60 minutes such that the weight ratio is carbon black:Terpineol:Triton=20:150:3 (S21).

The cathode-side gas diffusion layer paste and the anode-side gas diffusion layer paste are prepared in the same manner as in Example 1.

The surface of the carbon paper water repellent coated using FEP is evenly coated with the gas diffusion layer paste cooled to room temperature and then dried by a hot air dryer at 60° C. for 60 minutes (S27) The cathode-side gas diffusion layer is prepared by coating the carbon paper with the cathode-side gas diffusion layer paste for a second time subsequent to S27, and then drying the coated carbon paper again by a hot air dryer at 60° C. for 60 minutes (Sc28). Finally, the gas diffusion layer is completed when heat treated at 360° C. for 2 hours (S29).

### COMPARATIVE EXAMPLE 1

The carbon paper (TGPH060H from Toray Industries Inc.) that serves as a gas diffusion layer base material is water repellent coated using FEP as in Example 1. The carbon paste is prepared in the same manner as in Example 1.

The carbon paste and the low molecular fluororesin dispersed solution (Lubron LDW40E from Daikin Industries, Ltd.) are introduced into a hybrid mixer container such that the weight ratio is carbon paste:low molecular fluororesin (fluororesin content included in a dispersed solution)=20:1 and mixed in a mixing mode of the hybrid mixer for 15 minutes. After mixing, the hybrid mixer is switched from the mixing mode to the degassing mode to allow degassing for 1-3 minutes. The paste thus degassed is allowed to be naturally cooled so as to complete the cathode-side gas diffusion layer paste.

The anode-side gas diffusion layer paste is prepared in the same manner as in Examples 1 and 2.

The surface of the carbon paper water repellent coated using FEP is evenly coated with gas diffusion layer paste, whereupon the surface is dried at 60° C. for 60 minutes by a hot air dryer. The cathode-side gas diffusion layer is prepared by coating the carbon paper with the cathode-side gas diffusion layer paste for a second time subsequent to the above drying step, and then drying the coated paper again by a hot air dryer at 60° C. for 60 minutes. Finally, the gas diffusion layer is completed when heat treated at 360° C. for 2 hours.

### COMPARATIVE EXAMPLE 2

The carbon paper (TGPH060H from Toray Industries Inc.) that serves as a gas diffusion layer base material is water repellent coated using FEP as in Example 1. The carbon paste is also prepared in the same manner as in Example 1.

The carbon paste is introduced into a beaker and allowed to cool to 10-12° C. The polymer fluororesin (PTFE30J from E.I. du Pont de Nemours and Company) is introduced into the cooled carbon paste such that the weight ratio is carbon paste:polymer fluororesin (fluororesin content included in a dispersed solution)=173:5 and mixed with a glass stirrer for 3 minutes, allowing the mixture to cool while ensuring that no aggregates are formed. In this way, the gas diffusion layer is completed.

The surface of the carbon paper water repellent coated using FEP is evenly coated with gas diffusion layer paste, whereupon the surface is dried at 60° C. for 60 minutes by a hot air dryer. The cathode-side gas diffusion layer is prepared by coating the carbon paper with the cathode-side gas diffusion layer paste for a second time subsequent to the above drying step, and then drying the coated carbon paper by a hot air dryer at 60° C. for 60 minutes. Finally, the gas diffusion layer is completed when heat-treated at 360° C. for 2 hours. If the aggregation of gas diffusion layer paste advances while the coating proceeds, making it difficult to continue coating, or if the surface of carbon paper is not coated evenly, the coating apparatus is cleaned or the gas diffusion layer paste is exchanged before continuing the operation.

<Measurement of Paste Amount>

The weight of gas diffusion layer paste is measured using the gas diffusion layers of Example 1, Example 2, Comparative Example 1 and Comparative Example 2. Comparison was made between the amounts of gas diffusion layer paste per unit area of gas diffusion layer. The amount of gas diffusion layer paste coating is defined as given in expression (1) below.

$$D = \frac{{W}_{A} - {W}_{C}}{S} \qquad ( 1 )$$

where W_{A} denotes the overall weight of the gas diffusion layer coated with gas diffusion layer paste and then dried and heat treated; W_{C} denotes the weight of carbon paper before being coated with gas diffusion layer paste; and S denotes the area of the primary surface of carbon paper. Table 1 shows the results of measurements.

TABLE 1

| | AMOUNT OF CATHODE | AMOUNT OF ANODE |
|---|---|---|
| | (CA) PASTE COATING | (AN) PASTE COATING |
| EXAMPLE 1 | 1.44 mg/cm² | 1.60 mg/cm² |
| EXAMPLE 2 | 2.10 mg/cm² | 1.52 mg/cm² |
| COMPARATIVE | 2.13 mg/cm² | 1.51 mg/cm² |
| EXAMPLE 1 | | |
| COMPARATIVE | 2.08 mg/cm² | 1.47 mg/cm² |
| EXAMPLE 2 | | |

<Comparison of Workability>

Subsequently, measurements were made of time required to coat 40 base materials of the gas diffusion layers of Example 2 and Comparative Examples 1 and 2 with gas diffusion layer paste at room temperature of 20° C. and at humidity of 35-50%, in order to compare workability of coating the base material with gas diffusion layer paste. Table 2 shows the results of measurements. Similarly, measurements were made of the amount of gas diffusion paste that should be prepared to coat 40 base materials with gas diffusion layer paste. Table 3 shows the results of measurements.

Tables 2 and 3 list time required to coat with the gas diffusion layer pastes of Example 2 and Comparative Example 1 and the amount of gas diffusion layer pastes required to coat the base materials, respectively, presenting them as percentage of time required to coat with the gas diffusion paste of Comparative Example 2 (=100%) and the amount required to coat with the gas diffusion layer paste of Comparative Example 2 (=100%), respectively.

TABLE 2

| | TIME REQUIRED | TIME REQUIRED |
|---|---|---|
| | TO COAT CA | TO COAT AN |
| EXAMPLE 2 | 53 | 51 |
| COMPARATIVE | 49 | 51 |
| EXAMPLE 1 | | |
| COMPARATIVE | 100 | 100 |
| EXAMPLE 2 | | |

TABLE 3

| | AMOUNT OF | AMOUNT OF |
|---|---|---|
| | PASTE AT CA | PASTE AT AN |
| EXAMPLE 2 | 63 | 69 |
| COMPARATIVE | 60 | 69 |
| EXAMPLE 1 | | |
| COMPARATIVE | 100 | 100 |
| EXAMPLE 2 | | |

Since the gas diffusion layer paste of Example 1 only comprises low molecular fluororesin, the paste exhibits considerably low binding capacity and spreads well when applied to the base material. Thus, the paste requires less time to coat the base material and it is unlikely that the gas diffusion layer paste is hardened while coating the base material with gas diffusion layer paste. As a result, 40 base materials can be coated at a time without being interrupted by cleanup operations. The gas diffusion layer paste of Example 2 has polymer fluororesin mixed therein as a binding agent and so has higher viscosity than the paste of Example 1 and requires a longer time for coating accordingly. Still, time required for coating is significantly reduced (workability is improved) as compared to Example 2 since coating of on the order of 40 base materials can proceed without being interrupted by cleanup operations in the middle.

In contrast, despite the fact that the anode-side gas diffusion layer paste only comprises low molecular fluororesin, the paste requires more time for coating than the cathode-side gas diffusion layer paste of Comparative Example 1 and requires less time for coating than the cathode-side gas diffusion layer paste of Example 2. This is presumably because the anode-side gas diffusion layer paste is richer in fluororesin content than the cathode-side gas diffusion layer paste or because the amount of FEP as a water repellent agent applied to the carbon paper as a base material is larger than that of the cathode side.

Not only time required for coating but also the amount of gas diffusion layer paste required to coat the base material with gas diffusion layer paste is significantly reduced in Example 2 as compared to Comparative Example 2 where only polymer fluororesin is used. Of particular note is that reduction is more significant in the cathode than in the anode since the cathode-side layer is coated twice.

In the Examples and Comparative Examples, the base material was coated with a spatula. Other methods of coating may also be practiced. Whatever coating method is used, the gas diffusion layer pastes in Examples exhibit viscosity and sticking tendency more suitable for the purpose of coating than that of Comparative Example 2. Time required for coating and the amount of gas diffusion layer paste required for coating are thus reduced so that workability is improved.

<Performance Test>

A single cell 10 as shown in FIG. 1 was prepared using the gas diffusion layers of Examples 1 and 2 so that time-dependent change in cell voltage was measured. The single cell 10 was prepared by forming the water management layers 16 and 24 by coating with the paste for the gas diffusion layers 20 and 28 of each of Examples 1 and 2 and Comparative Examples 1 and 2, and by forming the catalyst layers 14 and 22 on the water management layers 16 and 24, respectively. The polymer electrolyte membrane (Nafion 112) is sandwiched between the water management layers 16 and 24. The cathode-side catalyst layer 14 was prepared by mixing Pt-coated carbon and electrolytic solution (20% Nafion solution) at a ratio of Pt-coated carbon:electrolytic solution=3:8. The anode-side catalyst layer 22 was prepared by mixing Pt—Ru supported carbon and electrolytic solution (20% Nafion solution) at a ratio of Pt—Ru supported carbon:electrolytic solution=1:2.

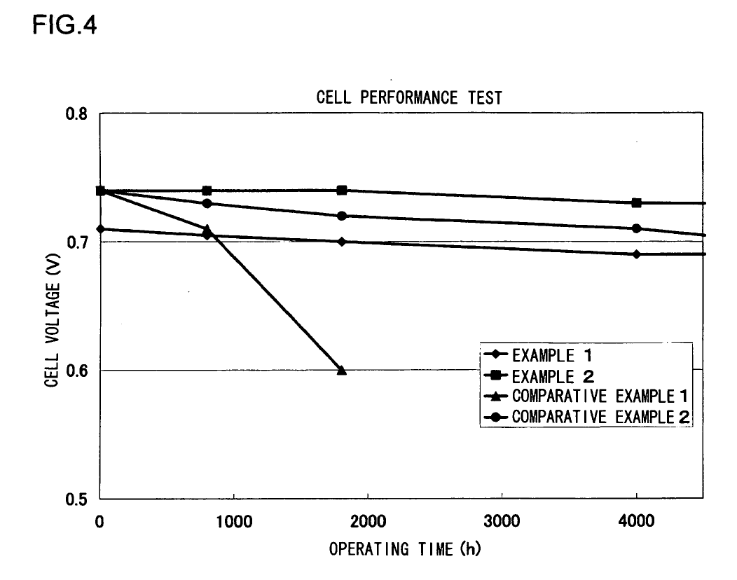

The operating condition of the single cell 10 was such that the oxygen utilization ratio=40% and the hydrogen utilization ratio=70%. FIG. 4 shows time-dependent change in cell voltage in single cells in which the gas diffusion layers of Examples 1 and 2 and Comparative Examples 1 and 2 are used.

FIG. 4 shows that the initial performance of the single cell in which the gas diffusion layer of Example 1 is used is poorer than that of Comparative Examples. It is found from this that, for favorable initial performance, the amount of cathode-side gas diffusion layer paste coating need be larger than the amount of anode-side gas diffusion layer paste coating in order to insure high performance at start up. The experiment also showed that it is desirable to coat with gas diffusion layer paste in the volume range of 1.92-2.24 mg/cm² at the cathode and in the volume range of 1.28-1.8 mg/cm² at the anode side. The cell voltage in Comparative Example 1 substantially drops when the operating time exceeds 1000 hours and halts its operation when 1800 hours is reached. The gas diffusion layer paste of Comparative Example 1 or, particularly, the cathode-side gas diffusion layer paste thereof only comprises low molecular fluororesin and as such has a low binding capacity. Moreover, the carbon paper constituting the cathode-side base material contains less FEP as a water repellent agent than that of the anode side. Therefore, the above-mentioned operating characteristics presumably result as a result of the water management layer being detached from the base material with the elapse of time, preventing the cathode-side gas diffusion layer from functioning to supply oxidant and discharge generated water. The cell according to Example 1 is lowest in initial performance of the four cells tested but maintains stable performance once started. The cell voltage it produces after 4000 hours since start-up is relatively low but the rate of voltage drop per unit hour is lower than that of Comparative Example 2 (the rage of voltage drop is 5 mV/1000 h in Example 1 and 7.5 mV/1000 h in Comparative Example 2).

Table 4 summarizes workability, initial performance, durability and overall evaluation for suitability in practical use (widespread use).

TABLE 4

| | | INITIAL | | |
|---|---|---|---|---|
| | WORKA- | PERFOR- | DURA- | OVERALL |
| | BILITY | MANCE | BILITY | EVALUATION |
| EXAMPLE 1 | ◯ | Δ | ◯ | ◯ |
| EXAMPLE 2 | ◯ | ◯ | ◯ | ⊚ |
| COMPARATIVE | ◯ | ◯ | X | X |
| EXAMPLE 1 | | | | |
| COMPARATIVE | X | ◯ | Δ | X |
| EXAMPLE 2 | | | | |

<Other Considerations>

In the embodiment, the base material was coated with paste with a spatula. Other methods of coating may also be practiced. Any method of coating the base material with a desired amount of gas diffusion layer paste serves the purpose. This may include coating methods such as screen printing. In Examples 1 and 2, Lubron LDW40E from Daikin Industries, Ltd. is used as low-molecular fluororesin and PTFE30J from E.I. du Pont de Nemours and Company is used as polymer fluororesin. Any low molecular fluororesin may be used as long as it is water repellent and does not have binding capacity (low in binding capacity). FEP may be used in place of polymer fluororesin. A caution required is that, FEP exhibits binding capacity when heat treated. Therefore, if FEP is used, the base material need be coated with gas diffusion layer paste before being heat treated. While FEP is described as being used to coat carbon paper as a base material for water repellent coating, polymer fluororesin (PTFE) may alternatively used for coating.

| | AMOUNT OF | AMOUNT OF |
|---|---|---|
| | PASTE AT CA | PASTE AT AN |
| EXAMPLE 2 | 63 | 69 |
| COMPARATIVE | 60 | 69 |
| EXAMPLE 1 | | |
| COMPARATIVE | 100 | 100 |
| EXAMPLE 2 | | |

The present invention is applicable to fuel cells of a type in which a polymer electrolyte is used in an electrolyte of a fuel cell and which are used in stationary fuel cell systems, vehicle fuel cell systems, mobile fuel cell systems and other applications.

What is claimed is:

1. A gas diffusion layer paste comprising:
a conductive material;
a water repellent material; and
a material with binding capacity.

2. The gas diffusion layer paste according to claim 1, wherein the water repellent material is a first fluororesin, and the material with binding capacity is a second fluororesin having a larger average molecular weight than the first fluororesin.

3. The gas diffusion layer paste according to claim 2, wherein the first fluororesin is polytetrafluoroethylene.

4. A gas diffusion layer paste comprising: a conductive base material; and a water management layer which is conductive and which manages moving water.

5. The gas diffusion layer according to claim 4, wherein the water management layer includes a conductive material and a water repellent material.

6. The gas diffusion layer according to claim 4, wherein the base material includes a third fluororesin having water repellency and sticking tendency.

7. A gas diffusion layer comprising; a first fluororesin having water repellency; and a second fluororesin having binding capacity.

8. The gas diffusion layer according to claim 7, further comprising a third fluororesin having water repellency and sticking tendency.

9. A polymer electrolyte fuel cell comprising:
an electrolyte;
a first electrode provided on one side of the electrolyte; and
a second electrode provided on the other side of the electrolyte, wherein
the first electrode is provided with a catalyst layer having a catalytic function, a conductive base material and a water management layer which is conductive and which manages water moving between the catalyst layer and the base material.

10. A polymer electrolyte fuel cell comprising:
an electrolyte; a first electrode provided on one side of the electrolyte; and
a second electrode provided on the other side of the electrolyte, wherein
the first electrolyte is provided with a catalyst layer which has a catalytic function and a gas diffusion layer according to claim 4.

11. A polymer electrolyte fuel cell comprising:
an electrolyte;
a first electrode provided on one side of the electrolyte; and
a second electrode provided on the other side of the electrolyte, wherein
the first electrolyte is provided with a catalyst layer which has a catalytic function and a gas diffusion layer according to claim 7.

12. A method of preparing gas diffusion layer paste comprising:
preparing conductive paste by mixing a conductive material, a detergent and a solvent; and
mixing the conductive paste, a first fluororesin and a second fluororesin.

13. The method of preparing gas diffusion layer paste according to claim 12, further comprising cooling the conductive paste before mixing the conductive paste, the first fluororesin and the second fluororesin.

14. A gas diffusion layer comprising:
a conductive base material; and
a water management layer which is provided on one side of the base material and which includes a conductive material and a water repellent material, wherein
the water management layer is provided on the base material in the volume range of 1.92 mg/cm²-2.24 mg/cm².

15. The gas diffusion layer according to claim 14, wherein the water management layer includes a first fluororesin as the water repellent material, and a second fluororesin which has binding capacity and which has a larger average molecular weight than the first fluororesin.

16. The gas diffusion layer according to claim 14, wherein the base material includes a third fluororesin which has water repellency and sticking tendency.

17. A fuel cell comprising:
an electrolyte;
a first electrode provided on one side of the electrolyte; and
a second electrode provided on the other side of the electrolyte, wherein
the first electrode is provided with a first catalyst layer which has a catalytic function and a first gas diffusion layer using the gas diffusion layer according to claim 14.

18. The fuel cell according to claim 17, wherein the second electrode is provided with a second catalyst layer which has a catalytic function, and a second gas diffusion layer including a base material and a water management layer, and wherein the weight of the water management layer formed in the first gas diffusion layer per unit area is larger than that of the water management layer formed in the second gas diffusion layer.
